(19) United States
(12) Patent Application Publication
(10) Pub. No.: US 2019/0102477 A1
(43) Pub. Date: Apr. 4, 2019

(54) NOVEL METADATA RELATIONSHIPS IN A CONFIGURATION MANAGEMENT DATABASE

(71) Applicant: ServiceNow, Inc., Santa Clara, CA (US)

(72) Inventors: Anson Barber Mayers, San Rafael, CA (US); Matthew Wilkofsky, Philadelphia, PA (US)

(21) Appl. No.: 15/723,756

(22) Filed: Oct. 3, 2017

(51) Int. Cl. G06F 17/30

(52) U.S. Cl. CPC G06F 17/30958; G06F 17/30572; G06F 17/30339

(57) ABSTRACT

Various embodiments are disclosed herein that provide users of a cloud computing system with the ability to display and/or traverse the various components, e.g., configuration items (CIs), stored in a configuration management database (CMDB), as well as the relationships between such components. The embodiments disclosed herein can visually display, e.g., in the form of tree, the types of relationships between various components stored in the CMDB, such as: business rules, script include files, database tables, user interface pages, and/or update sets. By seeing how the components of a CMDB are interrelated, users may more quickly understand how changes or customizations to one component of the system are likely to affect other components in the system. Likewise, understanding the interrelationships between the various types of components stored within the CMDB may also help users to more quickly troubleshoot issues and/or identify the root causes of problems occurring in their system.

### TECHNICAL FIELD

The embodiments described herein relate generally to configuration management databases (CMDBs) and, more particularly, to capturing and/or browsing novel relationships between various configuration items (CIs) and update sets stored in a CMDB.

### BACKGROUND

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations, which resources may be used to perform a variety computing functions, e.g., storing and/or processing large quantities of computing data. For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able redirect their resources to focus on their enterprise's core functions.

In today's communication networks, examples of cloud computing services a user may utilize include so-called software as a service (SaaS) and platform as a service (PaaS) technologies. SaaS is a delivery model that provides software as a service rather than an end product. Instead of utilizing a local network or individual software installations, software is typically licensed on a subscription basis, hosted on a remote machine, and accessed by client customers as needed. For example, users are generally able to access a variety of enterprise and/or information technology (IT)-related software via a web browser. PaaS acts an extension of SaaS that goes beyond providing software services by offering customizability and expandability features to meet a user's needs. For example, PaaS can provide a cloud-based developmental platform for users to develop, modify, and/or customize applications and/or automating enterprise operations without maintaining network infrastructure and/or allocating computing resources normally associated with these functions.

Within the context of cloud computing solutions for CMDBs, users may be asked to deal with ever increasing amounts of data, e.g., with respect to the number of CIs (and such CIs' relevant metadata, such as manufacturer, vendor, location, etc.) stored in the CMDB, as well as the data defining the relationships between such CIs that is also stored in the CMDB. In fact, the amount of data collected and stored in today's cloud computing solutions, such as CMDBs, may be orders of magnitude greater than what was historically collected and stored. Users tasked with automating business, IT, and/or other organization-related functions (e.g., incident tracking and/or help desk-related functions) may be required to navigate ever increasing amounts of data to properly and efficiently perform their job functions. As a result, it can be difficult for users of such CMDBs to appreciate or understand how the various CIs within a CMDB (as well as the customizations made thereto) are related to one another. Thus, debugging times, root cause analysis, update set analysis, and the high-level organization of CMDB components continue to be potential areas of improvement for software developers and application vendors. The following embodiments address improvements to the presentation and traversal of CMDB components, such as CIs and update sets, to address at least these and other issues relating to the interdependencies and topologies of potentially large data sets to provide an enhanced user experience.

### SUMMARY

The following presents a simplified summary of the disclosed subject matter in order to provide a basic understanding of some aspects of the subject matter disclosed herein. This summary is not an exhaustive overview of the technology disclosed herein. It is not intended to identify key or critical elements of the invention or to delineate the scope of the invention. Its sole purpose is to present some concepts in a simplified form as a prelude to the more detailed description that is discussed later.

In one embodiment, a system that provides the ability to display and/or traverse the various components stored in a CMDB comprises a user interface, a non-transitory memory, and one or more hardware processors configured to read instructions from the non-transitory memory. When executed, the instructions can cause the one or more hardware processors to receive a plurality of items of metadata related to CIs stored in the CMDB, such as: business rules, triggers (or other logical components), script include files, database tables, user interface pages, and/or update sets. Update sets, as discussed herein, refer to a collection of customizations made to a customer instance of a CMDB that can be transferred to another instance, and thus are not, strictly speaking, CIs themselves. However, according to the embodiments described herein, update sets may likewise be stored in the same types of CMDB database table(s) as the other types of CI items enumerated above (e.g., business rules, triggers, script include files, database tables, user interface pages, etc.), thereby enabling the graph creation process described in further detail herein.

Once the plurality of items of metadata are received, the system may determine a plurality of nodes, wherein each item in the plurality of items of metadata is associated with a respective node of the plurality of nodes. Next, the system may determine a plurality of edges, wherein each edge in the plurality of edges is associated with a relationship between two or more of the plurality of nodes, and wherein each relationship has a relationship type (e.g., a “contains” relationship, a “contained by” relationship, a “uses” relationship, a “calls” relationship, or a “called by” relationship). Information describing the various items of metadata and the types of relationships therebetween may be stored (and, optionally, updated as changes are made to the items of metadata and/or the relationships therebetween) in one or more tables in the CMDB, e.g., existing tables or new tables extended from existing tables in the CMDB.

Finally, the system may create a graph of the determined plurality of nodes and the determined plurality of edges. In some embodiments, the system may also be configured to display the created graph via the user interface, e.g., in a “tree” format, illustrating how the various nodes are connected to one another via the various edges representing the relationships between the respective nodes they connect. In some embodiments, the displayed graph may also include an indication of the relationship type of one or more of the edges in the graph.

Various visual filtering options may also be presented to a user viewing the graph via the user interface, e.g., an option to filter the graph to indicate (e.g., via displaying) only the nodes of the graph that are related to a first node selected by a user by less than or equal to a first number of edges. For example, if the first number of edges is 2, then the graph may be filtered to show only those nodes that are related to the first node selected by the user by 2 or less relationship edges (and hiding the other nodes and relationship edges stored in the graph). This filtering function may aid a user in more quickly determining what part or parts of their system are the root causes of an error or other undesired functionality that they are facing, as well as determining what additional components in a system are likely to be affected by updates that are made to a particular component (e.g., based on their dependency upon the particular updated component).

In still other filtering options, the graph may allow a user to filter the graph to display only nodes for items of metadata that are related to each other by two or more update sets. This type of filtering may, e.g., allow a user to more quickly locate pieces of the system that multiple developers (or system users) have recently customized or changed in some way, which may also indicate such pieces of the system as likely causes of the error or other undesired functionality currently being experienced by the system.

In other embodiments, methods to perform the various CMDB component presentation and traversal techniques summarized above are disclosed. In still other embodiments, non-transitory program storage devices are disclosed, which are readable by programmable control devices and which store instructions configured to cause one or more programmable control devices to perform the various CMDB component presentation and traversal techniques summarized above.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1 is a block diagram of an embodiment of a cloud computing system where embodiments of the present disclosure may operate.

FIG. 2 is a block diagram of an embodiment of a multi-instance cloud architecture where embodiments of the present disclosure may operate.

FIG. 3 is a block diagram of components and interactions of those components, according to one or more embodiments of the present disclosure.

FIG. 4 is a simplified diagram of a database table scheme, according to one or more embodiments of the present disclosure.

FIGS. 5A-5C illustrate various visualizations of the CIs within a CMDB and the relationships therebetween, according to one or more embodiments of the present disclosure.

FIG. 6 is a flowchart of an embodiment of a method that creates and displays a graph illustrating the CIs within a CMDB and the relationships therebetween.

FIG. 7 is a flowchart of an embodiment of a method that visually filters a graph illustrating the CIs within a CMDB and the relationships therebetween.

FIG. 8 is a flowchart of another embodiment of a method that visually filters a graph illustrating the CIs within a CMDB and the relationships therebetween.

FIG. 9 is a block diagram illustrating an embodiment of a computing system for use with techniques described herein.

### DESCRIPTION OF EMBODIMENTS

In the following description, for purposes of explanation, numerous specific details are set forth in order to provide a thorough understanding of the embodiments disclosed herein. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment.

The terms “a,” “an,” and “the” are not intended to refer to a singular entity, unless explicitly so defined, but, rather, are intended to include the general class of which a specific example may be used for illustration. The use of the terms “a” or “an” may therefore mean any number that is at least one, including “one,” “one or more,” “at least one,” and “one or more than one.” The term “or” means any of the alternatives and any combination of the alternatives, including all of the alternatives, unless the alternatives are explicitly indicated as mutually exclusive. The phrase “at least one of” when combined with a list of items, means a single item from the list or any combination of items in the list. The phrase does not require all of the listed items unless explicitly so defined.

As used herein, the term “computing system” refers to a single electronic computing device that includes, but is not limited to a single computer, virtual machine, virtual container, host, server, laptop, and/or mobile device, or to a plurality of electronic computing devices working together to perform the function described as being performed on or by the computing system.

As used herein, the term “medium” refers to one or more non-transitory physical media that together store the contents described as being stored thereon. Embodiments may include non-volatile secondary storage, read-only memory (ROM), and/or random-access memory (RAM).

As used herein, the term “application” refers to one or more computing modules, programs, processes, workloads, threads and/or a set of computing instructions executed by a computing system. Example embodiments of an application include software modules, software objects, software instances and/or other types of executable code.

As used herein, the term “configuration item” refers to a record for any component (e.g., computer, device, piece of software, database table, script, webpage, piece of metadata, etc.) in an enterprise network, for which all relevant data, such as manufacturer, vendor, location, etc. is stored in a CMDB.

As used herein, the term “business rule” refers to is a piece of code, e.g., JavaScript, that is configured to run whenever a record is inserted, updated, or deleted, or when a table is queried. A business rule can be set to run before or after the database action has occurred. In the case of a query, the business rule should run before the database operation, so that the data returned to the user is appropriate to his or her system privileges (e.g., based on user role). For example, a typical business rule might execute a script after a user updates an incident or escalates the priority of a change request.

As used herein, the term “user interface page” refers to a web page or other structured or formatted document that may be presented to a user of a CMDB, which may allow the user to, e.g., run a query, review an alert, update CI metadata, etc.

As used herein, the term “script include” refers to a script written in a scripting language, e.g., JavaScript, which is created and which are executed on a server. In some instances, script includes may be called from other client scripts and may be run in a client browser, from a business rule (e.g., a database trigger), or other places within a system. Scripts may be run in various situations, e.g., when a form is loaded, when a form is submitted, when content on a form is edited, etc.

Various exemplary embodiments are disclosed herein that provide users of a cloud computing system with the ability to display and/or traverse the various components, e.g., CIs, stored in a CMDB. These embodiments allow the user to fluidly and seamlessly explore the components of a CMDB, as well as the relationships therebetween. The embodiments disclosed herein can visually display the types of relationships between various items stored in the CMDB, such as: business rules, triggers (or other logical components), script include files, database tables, user interface pages, and/or update sets. By seeing how the components of a CMDB are interrelated, users may more quickly and accurately understand how changes or customizations to one component of the system are likely to affect other components in the system. Likewise, having a thorough understanding of the interrelationships between the various types of components stored within the CMDB may also help users to more quickly troubleshoot issues, identify the root cause of problems occurring in their system, and/or identify the types of CIs that are the leading causes of problems occurring in their system.

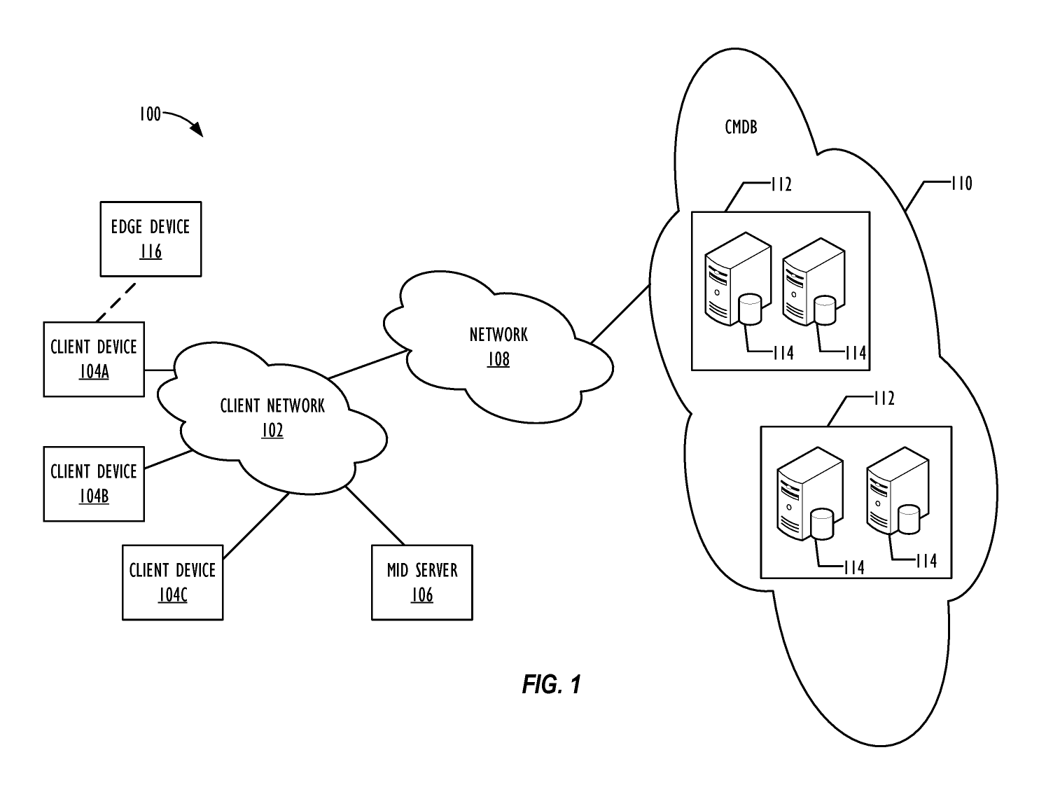

Turning now to FIG. 1, a schematic diagram of an embodiment of a computing system 100, such as a cloud computing system, where embodiments of the present disclosure may operate, is illustrated. Computing system 100 may include a client network 102, network 108 (e.g., the Internet), and developmental platform network 110. In one embodiment, the customer network 102 may be a local private network, such as local area network (LAN) that includes a variety of network devices that include, but are not limited to switches, servers, and routers. In another embodiment, the customer network 102 represents an enterprise network that could include one or more LANs, virtual networks, data centers 112, and/or other remote networks. As shown in FIG. 1, the customer network 102 is able to connect to one or more client devices 104A-C so that the client devices are able to communicate with each other and/or with the network hosting the CMDB platform service 110. The client devices 104A-C may be computing systems and/or other types of computing devices generally referred to as Internet of Things (IoT) devices that access cloud computing services, for example, via a web browser application or via an edge device 116 that may act as a gateway between the client device and a remote device. FIG. 1 also illustrates that the customer network 102 includes a management, instrumentation, and discovery (MID) server 106 that facilitates communication of data between the network hosting the CMDB platform service 110, other external applications, data sources, and services, and the customer network 102. Although not specifically illustrated in FIG. 1, the customer network 102 may also include a connecting network device (e.g., a gateway or router) or a combination of devices that implement a customer firewall or intrusion protection system.

FIG. 1 illustrates that customer network 102 is coupled to a network 108. The network 108 may include one or more computing networks available today, such as other LANs, wide area networks (WAN), the Internet, and/or other remote networks, in order to transfer data between the client devices 104A-C and the network hosting the CMDB platform service 110. Each of the computing networks within network 108 may contain wired and/or wireless programmable devices that operate in the electrical and/or optical domain. For example, network 108 may include wireless networks, such as cellular networks (e.g., Global System for Mobile Communications (GSM) based cellular network), WiFi® networks (WIFI is a registered trademark owned by Wi-Fi Alliance Corporation)), and/or other suitable radio-based network as would be appreciated by one of ordinary skill in the art upon viewing this disclosure. The network 108 may also employ any number of network communication protocols, such as Transmission Control Protocol (TCP) and Internet Protocol (IP). Although not explicitly shown in FIG. 1, network 108 may include a variety of network devices, such as servers, routers, network switches, and/or other network hardware devices configured to transport data over networks.

In FIG. 1, the network hosting the CMDB platform service 110 may be a remote network (e.g., a cloud network) that is able to communicate with the client devices 104A-C via the customer network 102 and network 108. The network hosting the CMDB platform service 110 provides additional computing resources to the client devices 104A-C and/or customer network 102. For example, by utilizing the network hosting the CMDB platform service 110, users of client devices 104A-C are able to build and execute applications, such as CMDBs or other automated processes for various enterprise, IT, and/or other organization-related functions. In one embodiment, the network hosting the CMDB platform service 110 includes one or more data centers 112, where each data center 112 could correspond to a different geographic location. Each of the data center 112 includes a plurality of server instances 114, where each server instance 114 can be implemented on a physical computing system, such as a single electronic computing device (e.g., a single physical hardware server) or could be in the form a multi-computing device (e.g., multiple physical hardware servers). Examples of server instances 114 include, but are not limited to a web server instance (e.g., a unitary Apache installation), an application server instance (e.g., unitary Java® Virtual Machine), and/or a database server instance, e.g., a unitary MySQL® catalog (MySQL® is a registered trademark owned by MySQL AB A COMPANY).

To utilize computing resources within the developmental platform network 110, network operators may choose to configure the data centers 112 using a variety of computing infrastructures. In one embodiment, one or more of the data centers 112 are configured using a multi-tenant cloud architecture, such that a single server instance 114, which can also be referred to as an application instance, handles requests and serves multiple customers. In other words, data centers with multi-tenant cloud architecture commingle and store data from multiple customers, where multiple customer instances are assigned to a single server instance 114. In a multi-tenant cloud architecture, the single server instance 114 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure to single server instance 114 causing outages for all customers allocated to the single server instance 114.

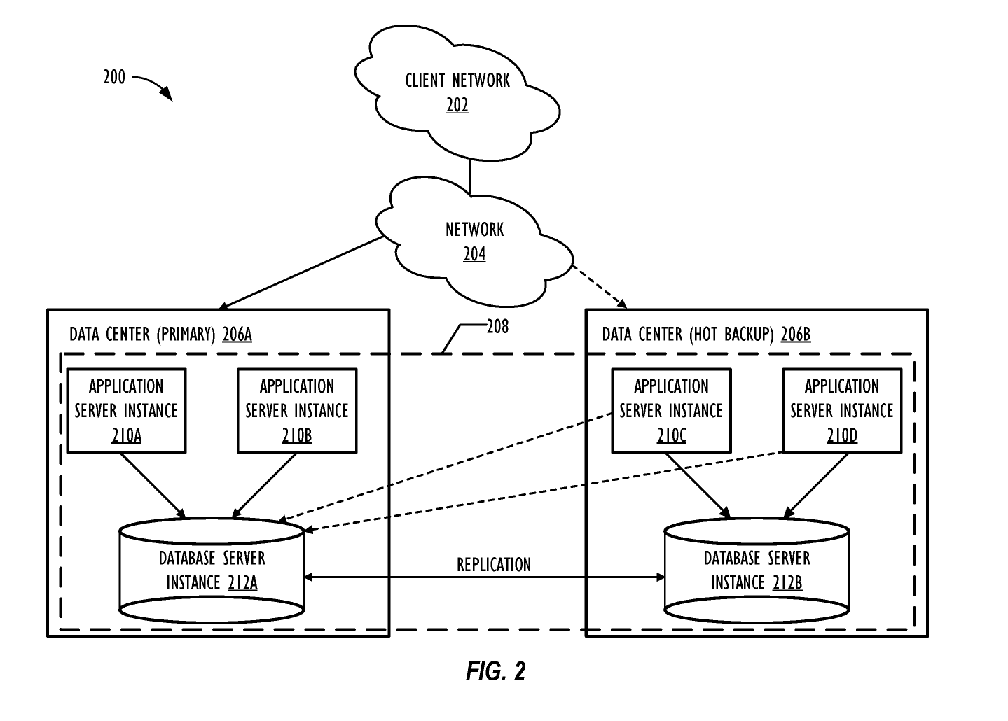

In another embodiment, one or more of the data centers 112 are configured using a multi-instance cloud architecture to provide every customer its own unique customer instance. For example, a multi-instance cloud architecture could provide each customer instance with its own dedicated application server and dedicated database server. In other examples, the multi-instance cloud architecture could deploy a single server instance 114 and/or other combinations of server instances 114, such as one or more dedicated web server instances, one or more dedicated application server instances, and one or more database server instances, for each customer instance. In a multi-instance cloud architecture, multiple customer instances could be installed on a single physical hardware server, where each customer instance is allocated certain portions of the physical server resources, such as computing memory, storage, and processing power. By doing so, each customer instance has its own unique software stack that provides the benefit of data isolation, relatively less downtime for customers to access the developmental platform network 110, and customer-driven upgrade schedules. An example of implementing a customer instance within a multi-instance cloud architecture will be discussed in more detail below with reference to FIG. 2.

In one embodiment, a customer instance may include one or more database tables designed for storing information describing one or more of the CIs stored in a CMDB and the various relationships (including the types of relationships) between such CIs. The system may also include one or more database listeners that can listen for changes (e.g., additions, deletions, updates, etc.) to various tables (e.g., metadata-extended tables, as will be described in further detail below) on client instances and update the one or more database tables based on any relevant changes that have taken place with the metadata describing the client's CIs and relationships. After characterizing the various relationships and relationship types between the CIs in a client's system, a tree-like data structure (i.e., consisting of one or more nodes and one or more edges connecting such nodes) may be generated to allow a user to visualize the interrelationships between the CIs in the system and browse the relevant relationship data for any given CI of interest.

FIG. 2 is a schematic diagram of an embodiment of a multi-instance cloud architecture 200 where embodiments of the present disclosure may operate. FIG. 2 illustrates that the multi-instance cloud architecture 200 includes a client network 202 that connects to two data centers 206a and 206b via network 204. Client network 202 and network 204 may be substantially similar to client network 102 and network 108 as described in FIG. 1, respectively. Data centers 206a and 206b can correspond to FIG. 1's data centers 112 located within developmental platform network 110. Using FIG. 2 as an example, a client instance 208 is composed of four dedicated application server instances 210a-210d and two dedicated database server instances 212a and 212b. Stated another way, the application server instances 210a-210d and database server instances 212a and 212b are not shared with other client instances 208. Other embodiments of the multi-instance cloud architecture 200 could include other types of dedicated server instances, such as a web server instance. For example, the client instance 208 could include the four dedicated application server instances 210a-210d, two dedicated database server instances 212a and 212b, and four dedicated web server instances (not shown in FIG. 2).

To facilitate higher availability of the client instance 208, the application server instances 210a-210d and database server instances 212a and 212b are allocated to two different data centers 206a and 206b, where one of the data centers 206 acts as a backup data center. In reference to FIG. 2, data center 206a acts as a primary data center 206a that includes a primary pair of application server instances 210a and 210b and the primary database server instance 212a for the client instance 208, and data center 206b acts as a secondary data center 206b to back up the primary data center 206a for a client instance 208. To back up the primary data center 206a for the client instance 208, the secondary data center 206 includes a secondary pair of application server instances 210c and 210d and a secondary database server instance 212b. The primary database server instance 212a is able to replicate data to the secondary database server instance 212b.

As shown in FIG. 2, the primary database server instance 212a may replicate data to the secondary database server instance 212b using, e.g., a Master-Master MySQL Binlog replication operation. The replication of data between data could be implemented by performing full backups weekly and daily incremental backups in both data centers 206a and 206b. Having both a primary data center 206a and secondary data center 206b allows data traffic that typically travels to the primary data center 206a for the client instance 208 to be diverted to the second data center 206b during a failure and/or maintenance scenario. Using FIG. 2 as an example, if the application server instances 210a and 210b and/or primary data server instance 212a fails and/or is under maintenance, data traffic for client instances 208 can be diverted to the secondary application server instances 210c and the secondary database server instance 212b for processing.

Although FIGS. 1 and 2 illustrate specific embodiments of a cloud computing system 100 and a multi-instance cloud architecture 200, respectively, the disclosure is not limited to the specific embodiments illustrated in FIGS. 1 and 2. For instance, although FIG. 1 illustrates that the developmental platform network 110 is implemented using data centers, other embodiments of the of the developmental platform network 110 are not limited to data centers and can utilize other types of remote network infrastructures. Moreover, other embodiments of the present disclosure may combine one or more different server instance into a single server instance. Using FIG. 2 as an example, the application server instances 210 and database server instances 212 may be combined into a single server instance. The use and discussion of FIGS. 1 and 2 are only examples to facilitate ease of description and explanation and are not intended to limit the disclosure to the specific examples.

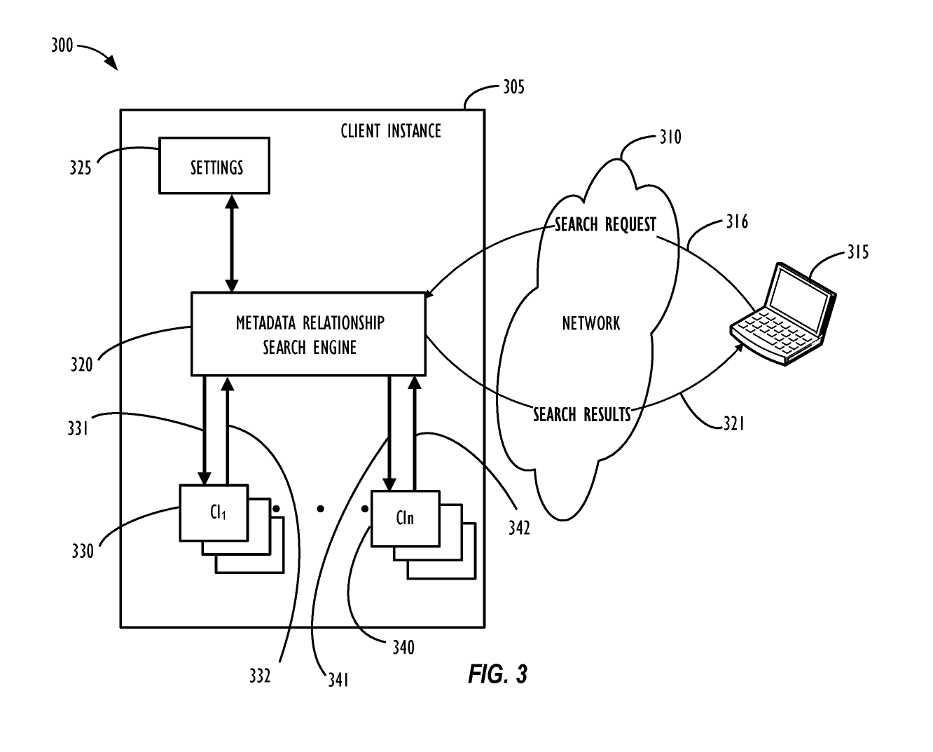

FIG. 3 illustrates a block diagram 300 of an embodiment of a network environment and hosted client instance 305 that may be used to support an improved CMDB metadata relationship browsing and traversal system, according to one or more disclosed embodiments. As illustrated in FIG. 3, network 310 is a further example of a network such as the Internet or one or more corporate networks such as network 108 of FIG. 1 and network 204 of FIG. 2. In this example, network 310 may represent a single network or a combination of networks that may be configured to transmit a search request 316 from a client device 315 to a metadata relationship search engine 320 and return search results 321 from search engine 320 to client device 315.

Client device 315 may be configured to communicate through network 310 with client instance 305 that may be hosted on a remote server or a remote server instance in a cloud infrastructure, as described above. In this example, client device 315 may be configured to execute a web browser interface and receive a user indication of a search request 316 to be transmitted to client instance 305 and search engine 320 within that client instance 305 for processing. Search engine 320 may receive search request 316 and obtain informational settings 325 from within client instance 325 pertaining to the processing of search request 316 (e.g., the name of a piece of metadata or a particular table to search). Alternatively, settings may be embedded within search request 316 without the need to reference settings 325.

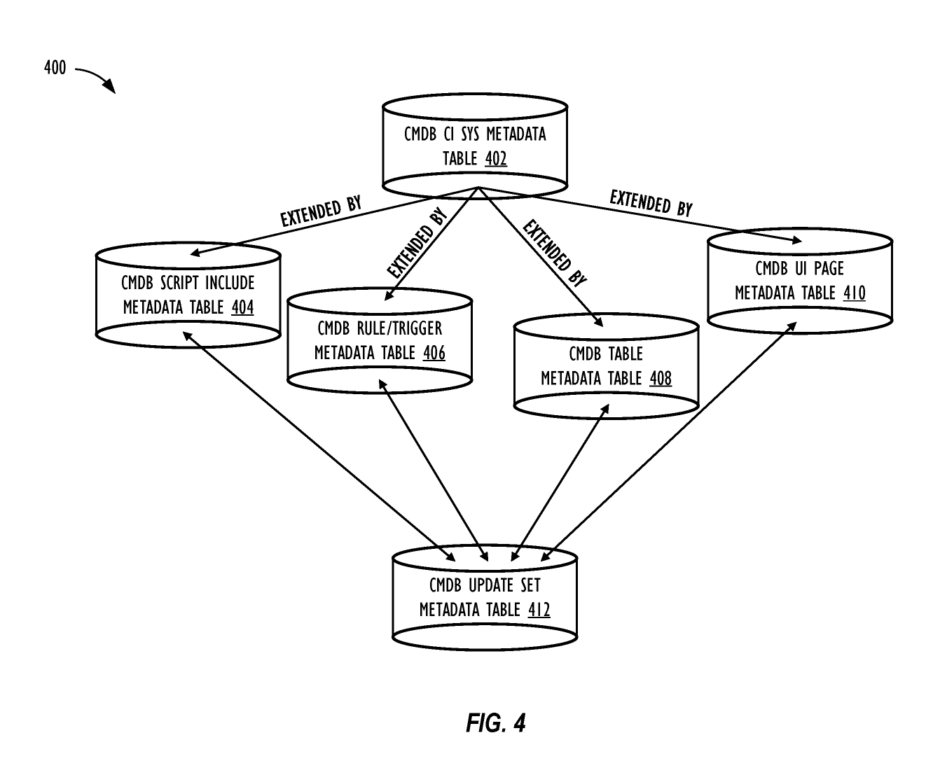

Once search engine 320 has obtained a sufficient amount of information pertaining to search request 316, the search process may be initiated as shown by interface lines 331, 341 to and from the various relevant CMDB tables storing CI metadata relationship information. As will be discussed in further detail with reference to FIG. 4, in some embodiments, these relevant tables may actually be extended from existing CMDB system metadata tables, specifically to capture information regarding the relationship between the metadata of the various CIs and update sets stored in the CMDB. The search request 316 may, e.g., comprise the name of a particular CI, a partial name of a CI, one more desired characteristics of CIs, a vendor name, a machine or server name, one or more pieces of metadata regarding an update set, etc., as well as a minimum or maximum number of degrees of separation from the CI(s) returned by the search request that the user wishes to pull back information for. Essentially, any piece of metadata regarding a CI (or update set) that the system has captured information for may be searched on by the user that is sending search request 316.

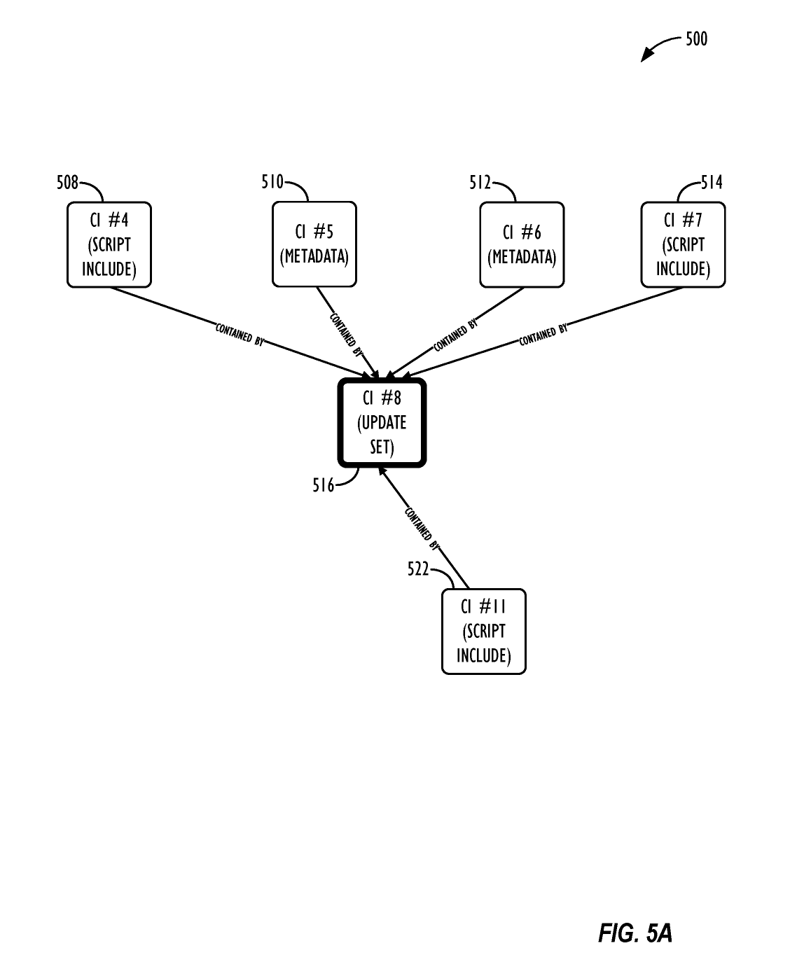

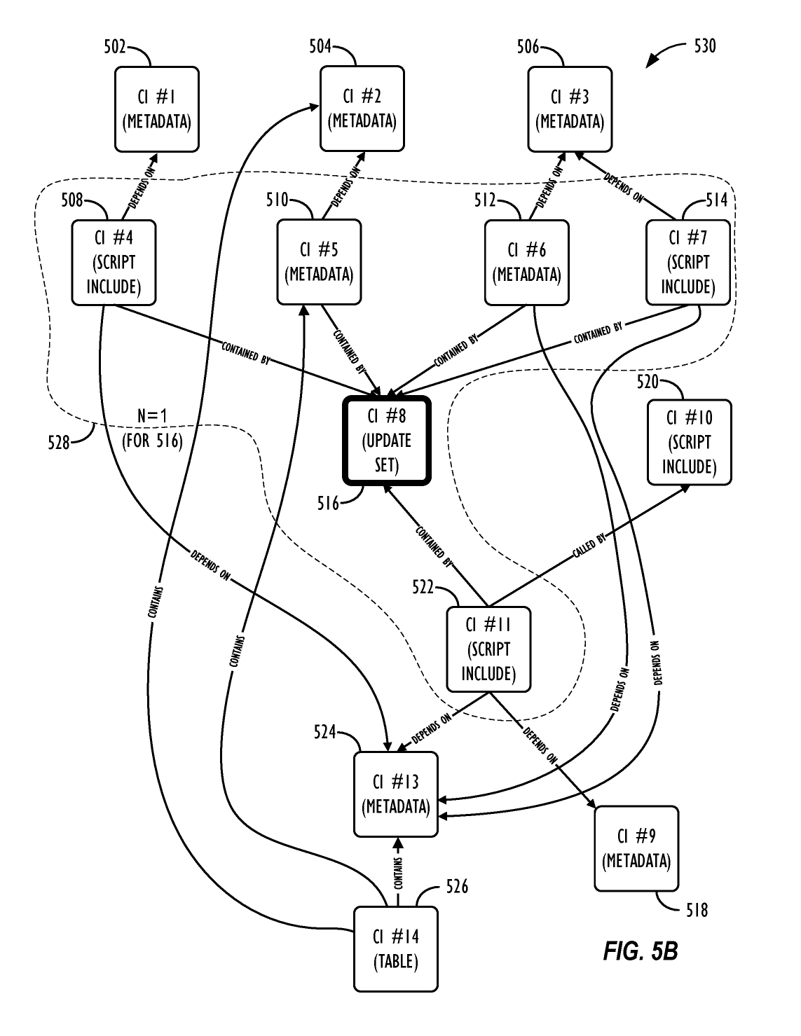

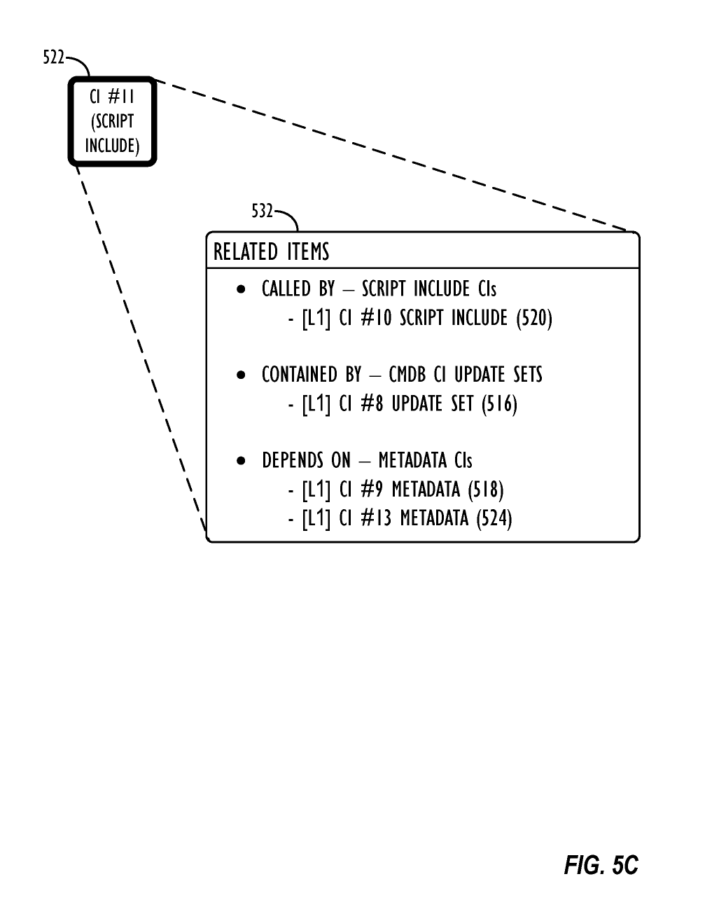

Each search request 316 may return a group of one or more CIs and/or update sets matching the search criteria from the aforementioned various relevant CMDB tables storing CI metadata relationship information. For example, a first search request may return a group of CIs, “CI group 1” (CI₁) 330, as shown by interface line 332, which will contain all the relevant CI and update set information and metadata (including relationship type information) necessary for the client instance 305 to generate a tree data structure (or other desired data structure) allowing the user to view and/or traverse the results of the search request, as will be described in greater detail with reference to FIGS. 5A-5C. Likewise, additional search requests may be handled by search engine 320, returning different search results (e.g., partially overlapping search results with other search queries or search results that do not share overlapping results with other search queries), as represented in FIG. 3 by “CI group n” (CIₙ) 340, and as shown by interface line 342. Again, each returned CI group will contain all the relevant CI and update set information and metadata (including relationship type information) necessary for the for the client instance 305 to generate a tree data structure (or other desired data structure) for the respective search query, e.g., to be displayed on client device 315.

Block diagram 300 illustrates an example of a portion of a service provider cloud infrastructure (e.g., network 110 of FIG. 1) connected via a network 310, such as the Internet, to a customer device 315 to provide a user interface to network applications, executing within a client instance 305, via a web browser, as an example. Network 310 is a further example of a network such as network 108 of FIG. 1 and network 204 of FIG. 2. Details of these networks are discussed above with reference to each of FIGS. 1 and 2 and are not discussed further here. Service provider cloud infrastructure client instance 305 illustrates cloud resources and server instances similar to those explained with respect to FIG. 2, but is illustrated here to show support for a metadata search capability within a single client instance 305. Of course, cloud provider infrastructure may be configured to support a plurality of end-user devices, such as end-user device 315, concurrently, wherein each end-user device is in communication with the single client instance 305. Also, cloud provider infrastructures may be configured to support any number of client instances, such as client instance 305, concurrently, with each of the instances in communication with one or more end-user devices. As mentioned above, an end-user may also interface with client instance 305 using an application that is executed within a web browser.

Referring now to FIG. 4, a simplified diagram 400 of a database table scheme is shown, according to one or more embodiments of the present disclosure. Exemplary database table scheme 400 is only meant to represent a portion of the total number of tables in a given CMDB. In particular, diagram 400 shows an exemplary set of tables that may be used to store information related to the relationships between various CIs and update sets stored in the CMDB. The first such table shown in FIG. 4 that will be discussed is labeled as a “CMDB CI System Metadata” table (402) to reflect the fact that it will store system metadata related to one or more CIs stored in the CMDB. According to some embodiments, the “CMDB CI System Metadata” table (402) may be created, e.g., by extending one or more existing tables in the CMDB, such as a generic “System Metadata” table, if one is present. As described above, the types of CIs for which information may be stored may include components such as: business rules, triggers (or other logical components), script include files, database tables, and/or user interface pages.

As is further illustrated in FIG. 4, according to some embodiments, additional CI-specific tables may be created, e.g., by extending the “CMDB CI System Metadata” table (402). In some embodiments, for example, there may be a separate “CMDB Script Include Metadata” table (404), a “CMDB Rule/Trigger Metadata” table (406), a “CMDB Table Metadata” table (408), and or a “CMDB UI page Metadata” table (410). Each such respective table may store records containing unique information, e.g., code, related to the type of CI that it contains information for. The information stored in each table may be any information that is deemed interesting from a relationship management point of view. In alternate embodiments, all of the types of CIs for which metadata relationship information may be stored into a single table, rather than being broken out into individual tables, such as tables 404, 406, 408, and 410 in FIG. 4. Of course, in the case of a single table being used to store all the CI system metadata information, the single table may have one or more columns that store data that will be irrelevant to one or more of the CI types stored in the table, and thus have empty values in those columns for such CIs.

Also shown in FIG. 4 is a “CMDB Update Set Metadata” table (412). As mentioned above, update sets are simply collections of customizations made to a given customer instance of a CMDB that can be transferred to another instance, and thus are not, strictly speaking, CIs themselves. Thus, “CMDB Update Set Metadata” table (412) is not shown as extending the “CMDB CI System Metadata” table (402). However, the “CMDB Update Set Metadata” table (412) may be used to tie together the relationships between each CI within a given update set and show how each CI in the update set is (or is not) related to one another. The techniques described herein provide a user with the ability to see what CIs were ‘touched’ (i.e., affected) by a given update set, as well as dependencies of those files.

Referring now to FIG. 5A, a first visualization 500 of various CIs within a CMDB and the relationships therebetween is shown, according to one or more embodiments of the present disclosure. In particular, visualization 500 comprises a tree-like graph, comprising a set of six “nodes” (508, 510, 512, 514, 516, and 522) and the corresponding “edges” connecting the various nodes to one another. In this embodiment, each node in the graph 500 comprises either a CI or an update set stored in the CMDB. For example, the graph 500 may comprise the result of a search query run by a user of the system for the particular CI named “CI #8”, wherein the query may have been limited to those other CIs in the CMDB related to “CI #8” by only a single level of relationship, i.e., a single edge in graph 500. As illustrated in graph 500, each edge in the graph may also indicate the type of relationship represented by the edge. For example, CI #4 (508) comprises a script include CI that is “contained by” update set CI #8 (516). Likewise, CI #5 (510) comprises a metadata CI that is “contained by” update set CI #8 (516), CI #6 (512) comprises a metadata CI that is “contained by” update set CI #8 (516), CI #7 (514) comprises a script include CI that is “contained by” update set CI #8 (516), and CI #11 (522) comprises a script include CI that is “contained by” update set CI #8 (516).

As may be understood, graph 500 may be displayed via a user interface using a variety of display options. For example, the graph may be displayed as a vertically-aligned tree, a horizontally-aligned tree, a radial graph, or any other desired configuration. Likewise, selecting any of the individual CIs (or update sets) in the graph (e.g., via the use of a keyboard, mouse, touch input, or other input mechanism), may highlight (e.g., by increasing the thickness or changing the color of) the various relationship edges emanating from the selected CI (or update set). According to some embodiments, a user may also be able to specify the “blast radius” from the selected CI (or update set) which he or she would like to see highlighted or displayed. For example, all CIs within one relationship edge from update set CI #8 (516), or all CIs within three relationship edges, etc. In some instances, knowing the most ‘related’ components in the CMDB to a CI that is causing an error may help a user to identify a root cause, find a solution to the error being experienced, or identify other components in the system likely to be impacted by any changes to the error-causing CI.

Referring now to FIG. 5B, a second visualization 530 of various CIs within a CMDB and the relationships therebetween is shown, according to one or more embodiments of the present disclosure. Graph 530 contains several additional CIs to the CIs shown in the graph 500 of FIG. 5A. Dashed line 528 encloses the aforementioned CIs that are within a “blast radius” of one relationship edge from the selected update set CI #8 (516). As shown in FIG. 5B, additional CIs have been returned by the search query that resulted in graph 530. In particular: CI #1 (502) comprises a metadata CI that CI #4 (508) “depends on”; CI #2 (504) comprises a metadata CI that CI #5 (510) “depends on” and that table CI #14 (526) “contains”; CI #3 (506) comprises a metadata CI that CI #6 (512) and CI #7 (514) “depend on”; CI #10 (520) comprises a script include CI that is “called by” CI #11 (522); CI #13 (524) comprises a metadata CI that CI #4 (508), CI #11 (522), CI #6 (512), and CI #7 (514) each “depend on” and that table CI #14 (526) “contains”; and CI #14 (526), as mentioned above, comprises a table CI that “contains” CI #2 (504), CI #5 (510), and CI #13 (524).

As mentioned above, the graph may be visually filtered (e.g., via highlighting or hiding particular edges or nodes) based on a selected blast radius from selected CI. These visual filtering techniques may be applied without running a new search query, so long as the relevant CIs and/or update sets were returned in the results of the initial search query executed by a user. However, if a user desired to greatly increase the scope of what was being visually displayed by the graph (e.g., a “blast radius” of 10 relationship edges), a new search query may have to be executed to return a CI group containing all the relevant CI and update set information and metadata necessary for the generation of the updated tree data structure, e.g., as described above with reference to FIG. 3.

In still other embodiments, the graph may be filtered by showing only CIs that are related to greater than or equal to a first desired number of update sets. Such a type of search query/filtering may provide the user with insight into the CIs which multiple other users have recently updated or customized in some way, which may provide an indication of a part of the system that is a likely root cause of instability or errors observed in the system.

In still other embodiments, the graph may be filtered by showing only certain relationship types (e.g., only “contained by” relationships) or only certain CI types (e.g., only “script include” CIs). In still other embodiment, the graph may allow sequential filtering, e.g., filtering first by a particular update set, and then by a certain relationship type or CI type of the items in the selected update set. Other customizations of the visual interface are also possible, based on the desires of a given implementation and the types of information stored in the relevant CI system metadata tables.

Referring now to FIG. 5C, a detailed visualization 532 of the relevant relationships for a particular CI, CI #11 (522), is shown, according to one or more embodiments of the present disclosure. According to some embodiments, the detailed visualization 532 may be presented via a visual user interface in response to a user's selection of CI #11 (522), e.g., via the use of a keyboard, mouse, touch input, or other input mechanism. As illustrated in FIG. 5C, the related items of CI #11 (522) include: CI #10 (520), which is a script include that is called by CI #11 (522); CI #8 (516), which is an update set by which contains CI #11 (522) is contained; and CI #9 (518) and CI #13 (524), which are metadata CIs upon which CI #11 (522) depends. The indicator [L1] in visualization 532 indicates that each of the listed related items are Level-1 relations of the selected CI #11 (522), i.e., related by only a single relationship edge in the graph 530. Of course, if Level-2 or Level-3 relations of CI #11 (522) were also shown in visualization 532, visualization 532 may contain additional rows. In some embodiments, the related items may be sorted by relationship type (as shown in FIG. 5C) and then optionally further sorted by relationship distance, e.g., Level-1 related items, followed by Level-2 related items, and so forth.

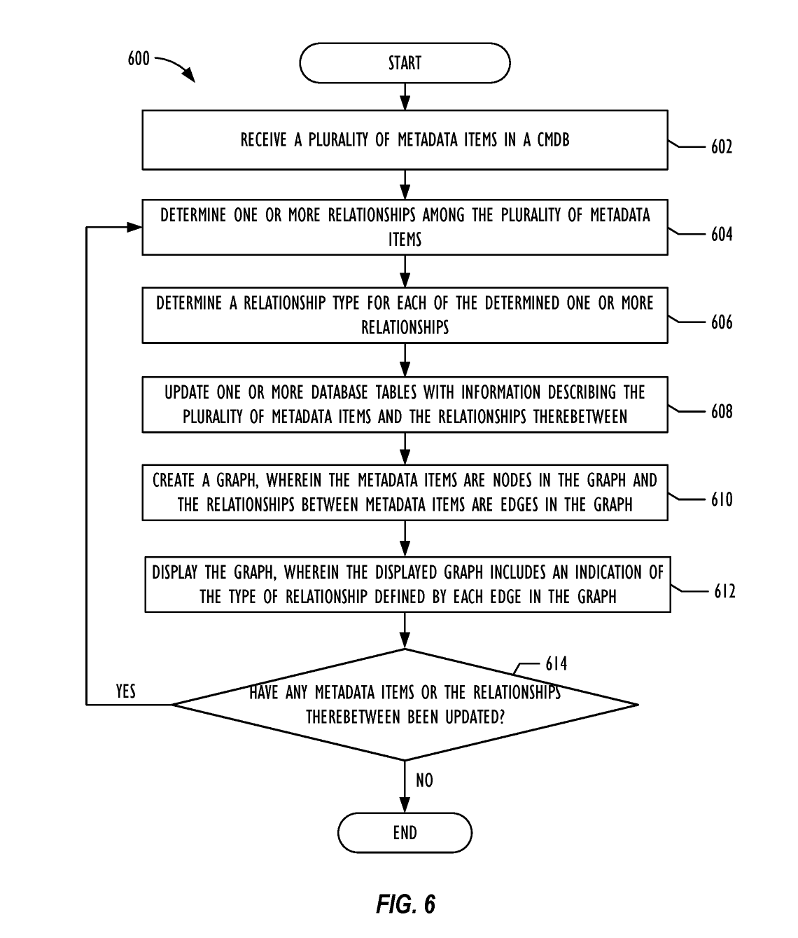

Referring now to FIG. 6, a flowchart 600 of an embodiment of a method that creates and displays a graph illustrating the CIs within a CMDB and the relationships therebetween is shown. First, at Step 602, a client instance may receive a plurality of metadata items regarding components stored in a CMDB. The components may, e.g., comprise CIs and/or update sets. Next, at Step 604, the method may determine one or more relationships that exist among the plurality of metadata items. At Step 606, a relationship type may be determined for each of the aforementioned relationships between the metadata items. As described above, many different types of relationships may be determined, and the relationships may be between many different (and widely varying) components of a client's enterprise system. For example, a non-limiting list of potential relationship types includes the following: a “contains” relationship; a “contained by” relationship; a “uses” relationship; a “used by” relationship; a “calls” relationship; and a “called by” relationship. Other relationship types may be defined for a given implementation and/or be created in a customized fashion by a given client. Next, at Step 608, the method may update one or more database tables with information describing the plurality of metadata items and the relationships therebetween. As described above with respect to FIG. 4, this data may be stored in separate individual tables for each CI type that is tracked by the system, or it may be flattened and stored together in a single table.

At Step 610, the method may create a graph reflecting the identities of (and relationships between) one or more CIs or update sets stored in the CMDB. According to some embodiments, e.g., such as those described above with respect to FIGS. 5A-5C, the nodes in the graph may correspond to the various metadata items, and the edges in the graph connecting the nodes may correspond to the respective relationships between the various items. The created graph may be as small as a single CI that matches a search query, may involve only the CIs contained in a single update set, or may involve all of the CIs stored in a CMDB. Once it has been created, at Step 612, the graph may be displayed, e.g., via a visual user interface. In some embodiments, the graph may include a selectable option to turn on or off the display of the relationship type of each edge. As described above, the graph may also optionally be filtered by a desired number (or degrees) of relationship edges from a selected one or more nodes.

At Step 614, the method may employ a database change ‘listener’ program, wherein any changes, e.g., updates, insertions, or deletions, to a client's relevant database tables may be monitored and reported back to the CMDB, e.g., in a queue. Based on the monitored changes, the process may determine whether any metadata items or the relationships therebetween have been updated in a way that would cause the system to need to update its relevant CMDB CI System Metadata tables. If such an update has occurred (i.e., ‘YES’ at Step 614), the process may return to Step 604 to re-determine the existing relationships and relationship types between the relevant metadata items, updating the relevant CMDB CI System Metadata tables and updating (if necessary) and displaying the graph again to reflect and updates made to the various system components. In some embodiments, changes in the change queue may be processed in a so-called ‘First In, First Out’ (FIFO) fashion. If, instead, no relevant updates have occurred, e.g., after the passage of some threshold amount of time (i.e., ‘NO’ at Step 614), the process may end. Of course, in some embodiments, method 600 may be in a constant state of listening for changes to the client's enterprise information and updating the graphical representation of such information accordingly, as necessary.

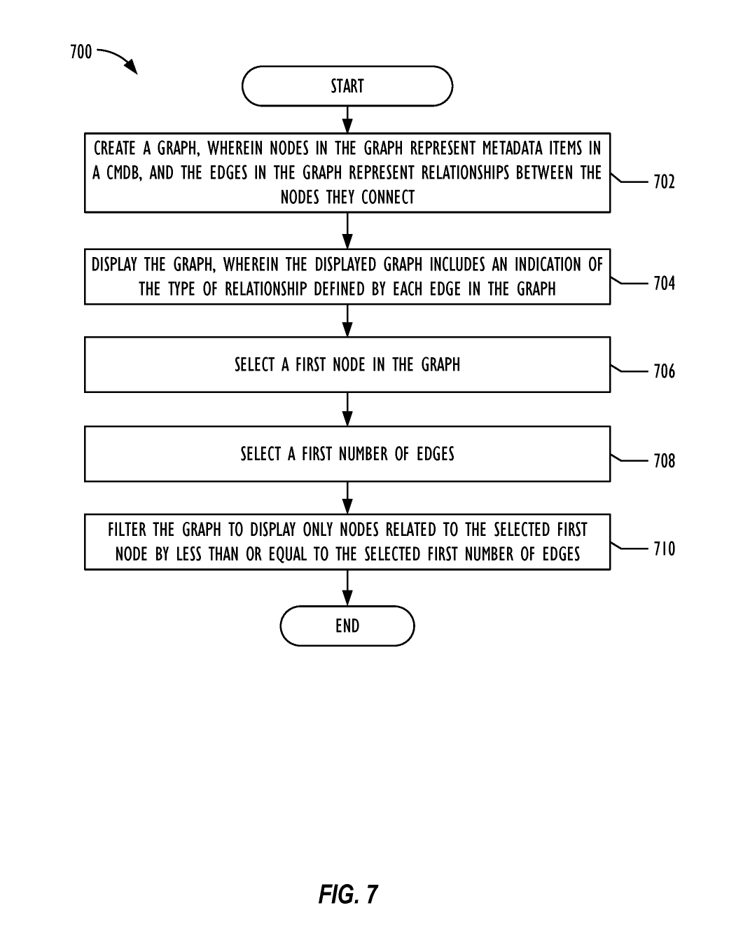

Referring now to FIG. 7, a flowchart 700 of an embodiment of a method that visually filters a graph illustrating the CIs within a CMDB and the relationships therebetween is shown. First, at Step 702, a graph may be created (e.g., via any of the techniques described above), wherein the nodes in the graph represent metadata items in a CMDB, and the edges in the graph represent the relationships between the respective nodes that they connect. Next, at Step 704, the initial configuration of the graph may be displayed, e.g., including an indication of the type of relationship defined by each of the edges in the graph. At Step 706, a user may select a first node in the graph. At Step 708, a user may further select a first number of edges. Finally, at Step 710, the graph may be filtered to highlight or display only those nodes related to the selected first node by less than or equal to the selected first number of edges. The number of CIs that are highlighted or displayed for a given selected node within the selected number of edges is also referred to herein as a “blast radius.” The farther out that a “blast radius” is extended, the more tenuous of a link the items at the outer edge of the blast radius may be likely to have with the selected node at the center of the “blast.” Understanding the closeness of a relationship between two CIs and/or update sets may help in debugging an error or determining one or more likely root causes of anomalous system behavior. For example, a script include that is called by ten other script includes in a given update set that is causing the system to crash is more likely to be the script include that is the source of the system crashing, since it is called by so many other components within the system.

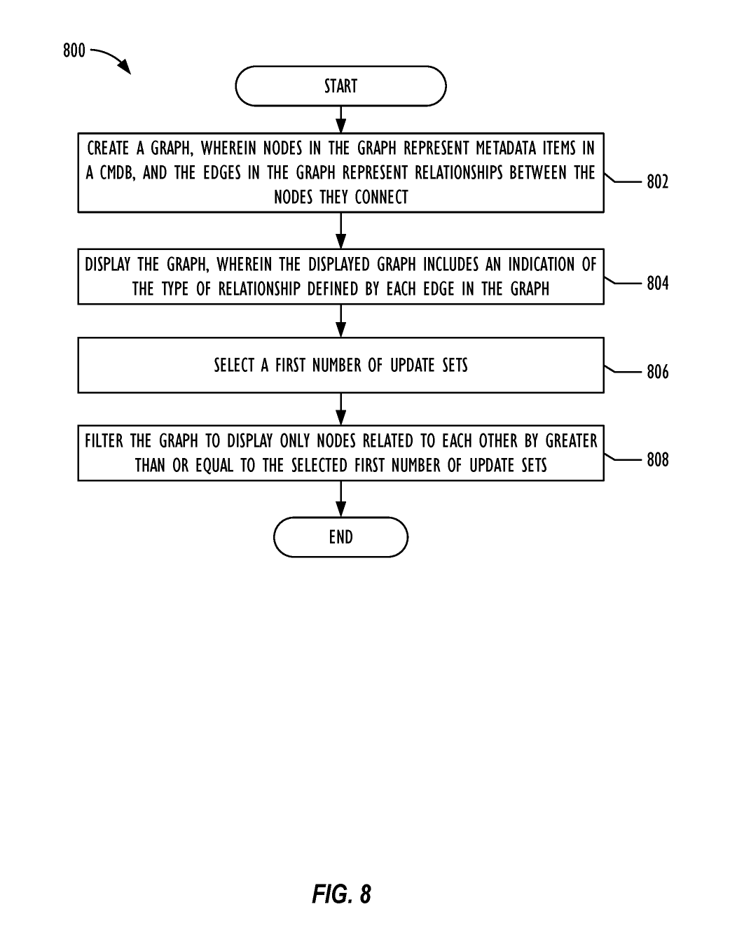

Referring now to FIG. 8, a flowchart 800 of another embodiment of a method that visually filters a graph illustrating the CIs within a CMDB and the relationships therebetween is shown. The setup to method 800 is similar to method 700, with method 800 differing only by the type of filtering that is ultimately performed on the graph by a user. For instance, method 800 also starts, at Step 802, by creating the aforementioned graph of the relevant CIs and/or update sets and respective relationships therebetween. Next, at Step 804, the initial configuration of the graph may be displayed, e.g., including an indication of the type of relationship defined by each of the edges in the graph. At Step 806, a user may select a first number of update sets. At Step 808, the graph may be filtered to highlight or display only those nodes related to each other by greater than or equal to the selected first number of update sets. As mentioned above, this may help a user to determine components within the system that multiple developers (or system users) have customized or changed in some way, which may also indicate that such components of the system are likely causes of the error or other undesired functionality currently being experienced by the system.

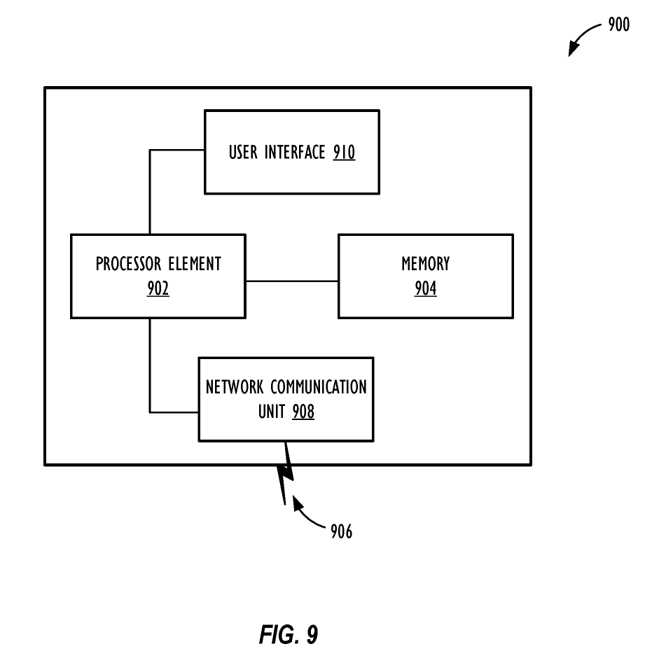

Referring now to FIG. 9, a block diagram illustrates a computing device 900 that may be used for implementing one or more of the techniques described herein. For example, the computing device 900 illustrated in FIG. 9 could represent a client device or a physical server device. As shown in FIG. 9, the computing device 900 can include can also include one or more input/output devices, such as a network communication unit 908 that could include a wired communication component and/or a wireless communications component 906, which can be coupled to processor element 902. The network communication unit 908 can utilize any of a variety of standardized network protocols, such as Ethernet, TCP/IP, to name a few of many protocols, to effect communications between devices and comprise one or more transceiver(s) that utilize the Ethernet, power line communication (PLC), WiFi®, and/or other communication methods.

The computing system 900 includes a processing element 902 that contains one or more hardware processors, where each hardware processor may have a single or multiple processor cores. In one embodiment, the processing element 902 may include at least one shared cache that stores data (e.g., computing instructions) that are utilized by one or more other components of processing element 902. For example, the shared cache may be locally cached data stored in a memory for faster access by components of the processing elements 902. In one or more embodiments, the shared cache may include one or more mid-level caches, such as level 2 (L2), level 3 (L3), level 4 (L4), or other levels of cache, a last level cache (LLC), or combinations thereof. Examples of processors include, but are not limited to a central processing unit (CPU) such as a microprocessor. Although not illustrated in FIG. 9, the processing element 902 may also include one or more other types of hardware processing components, such as graphics processing units (GPU), application specific integrated circuits (ASICs), field-programmable gate arrays (FPGAs), and/or digital signal processors (DSPs).

FIG. 9 illustrates that memory 904 may be operatively coupled to processing element 902. Memory 904 may be a non-transitory medium configured to store various types of data. For example, memory 904 may include one or more memory devices that comprise a non-volatile storage device and/or volatile memory. Volatile memory, such as random access memory (RAM), can be any suitable non-permanent storage device. The non-volatile storage devices can include one or more disk drives, optical drives, solid-state drives (SSDs), tap drives, flash memory, read only memory (ROM), and/or any other type memory designed to maintain data for a duration time after a power loss or shut down operation. In certain instances, the non-volatile storage device may be used to store overflow data if allocated RAM is not large enough to hold all working data. The non-volatile storage device may also be used to store programs that are loaded into the RAM when such programs are selected for execution.

Persons of ordinary skill in the art are aware that software programs may be developed, encoded, and compiled in a variety computing languages for a variety software platforms and/or operating systems and subsequently loaded and executed by processing element 902. In one embodiment, the compiling process of the software program may transform program code written in a programming language to another computer language such that the processing element 902 is able to execute the programming code. For example, the compiling process of the software program may generate an executable program that provides encoded instructions (e.g., machine code instructions) for processor 902 to accomplish specific, non-generic, particular computing functions.

After the compiling process, the encoded instructions may then be loaded as computer executable instructions or process steps to processing element 902 from storage (e.g., memory 904) and/or embedded within the processing element 902 (e.g., cache). Processing element 902 can execute the stored instructions or process steps in order to perform instructions or process steps to transform the computing device into a non-generic, particular, specially programmed machine or apparatus. Stored data, e.g., data stored by a storage device, can be accessed by processing element 902 during the execution of computer executable instructions or process steps to instruct one or more components within the computing device 900.

A user interface 910 can include a display, positional input device (such as a mouse, touchpad, touchscreen, or the like), keyboard, or other forms of user input and output devices. The user interface 910 can be coupled to processor element 902. Other output devices that permit a user to program or otherwise use the computing device can be provided in addition to, or as an alternative to, network communication unit 908. When the output device is (or includes) a display, the display can be implemented in various ways, including by a liquid crystal display (LCD), a cathode-ray tube (CRT), or a light emitting diode (LED) display, such as an organic LED (OLED) display. Persons of ordinary skill in the art are aware that the computing device 900 may comprise other components well known in the art, such as sensors, powers sources, and/or analog-to-digital converters, not explicitly shown in FIG. 9. For ease of discussion, FIG. 9 does not include further explanation of these other components well known in the art.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. It should be noted that the discussion of any reference is not an admission that it is prior art to the present invention, especially any reference that may have a publication date after the priority date of this application

What is claimed is:

1. A non-transitory program storage device, readable by a programmable control device and comprising instructions stored thereon to cause one or more programmable control devices to:
receive a plurality of items of metadata stored in a configuration management database (CMDB);
determine a plurality of nodes, wherein each item in the plurality of items of metadata is associated with a respective node of the plurality of nodes;
determine a plurality of edges, wherein each edge in the plurality of edges is associated with a relationship between two or more of the plurality of nodes, and wherein each relationship has a relationship type; and
create a graph of the determined plurality of nodes and the determined plurality of edges.

2. The non-transitory program storage device of claim 1, wherein the instructions further cause the one or more programmable control devices to:
store each of the relationships in one or more database tables extended from existing tables in the CMDB.

3. The non-transitory program storage device of claim 1, wherein the plurality of items of metadata comprise information describing at least one of the following types of items: a rule; a trigger; a script include; a table; a user interface page; or an update set.

4. The non-transitory program storage device of claim 1, wherein the types of relationships comprise at least one of the following types of relationships: a “contains” relationship; a “contained by” relationship; a “uses” relationship; a “calls” relationship; or a “called by” relationship.

5. The non-transitory program storage device of claim 1, wherein a first one of the items of metadata comprises an update set and a second one of the items of metadata comprises one of the following types of items: a rule; a script include; a table; or a user interface page.

6. The non-transitory program storage device of claim 1, wherein the instructions further cause the one or more programmable control devices to:
display the graph via a user interface, wherein the displayed graph includes an indication of the relationship type of each edge in the graph.

7. The non-transitory program storage device of claim 6, wherein the instructions further cause the one or more programmable control devices to:
filter the graph to display only nodes for items of metadata that are related to each other by two or more update sets.

8. The non-transitory program storage device of claim 6, wherein the instructions further cause the one or more programmable control devices to:
indicate all nodes of the graph that are related, by less than or equal to a first number of edges, to a first node selected by a user.

9. A system comprising:
a user interface;
a non-transitory memory; and
one or more hardware processors configured to read instructions from the non-transitory memory to cause the system to:
receive a plurality of items of metadata stored in a CMDB;
determine a plurality of nodes, wherein each item in the plurality of items of metadata is associated with a respective node of the plurality of nodes;
determine a plurality of edges, wherein each edge in the plurality of edges is associated with a relationship between two or more of the plurality of nodes, and wherein each relationship has a relationship type; and
create a graph of the determined plurality of nodes and the determined plurality of edges.

10. The system of claim 9, wherein the instructions read by the one or more hardware processors further cause the system to:
store each of the relationships in one or more database tables extended from existing tables in the CMDB.

11. The system of claim 9, wherein the plurality of items of metadata comprise information describing at least one of the following types of items: a rule; a trigger; a script include; a table; a user interface page; or an update set.

12. The system of claim 9, wherein the types of relationships comprise at least one of the following types of relationships: a “contains” relationship; a “contained by” relationship; a “uses” relationship; a “calls” relationship; or a “called by” relationship.

13. The system of claim 9, wherein a first one of the items of metadata comprises an update set and a second one of the items of metadata comprises one of the following types of items: a rule; a script include; a table; or a user interface page.

14. The system of claim 9, wherein the instructions read by the one or more hardware processors further cause the system to:
display the graph via the user interface, wherein the displayed graph includes an indication of the relationship type of each edge in the graph.

15. The system of claim 14, wherein the instructions read by the one or more hardware processors further cause the system to:
filter the graph to display, via the user interface, only nodes for items of metadata that are related to each other by two or more update sets.

16. The system of claim 14, wherein the instructions read by the one or more hardware processors further cause the system to:
indicate all nodes of the graph that are related, by less than or equal to a first number of edges, to a first node selected by a user.

17. A computer-implemented method, comprising:
receiving a plurality of items of metadata stored in a CMDB;
determining a plurality of nodes, wherein each item in the plurality of items of metadata is associated with a respective node of the plurality of nodes;
determining a plurality of edges, wherein each edge in the plurality of edges is associated with a relationship between two or more of the plurality of nodes, and wherein each relationship has a relationship type; and
creating a graph of the determined plurality of nodes and the determined plurality of edges.

18. The method of claim 17, further comprising:
storing each of the relationships in one or more database tables extended from existing tables in the CMDB.

19. The method of claim 17, wherein the plurality of items of metadata comprise information describing at least one of the following types of items: a rule; a trigger; a script include; a table; a user interface page; or an update set.

20. The method of claim 17, wherein the types of relationships comprise at least one of the following types of relationships: a “contains” relationship; a “contained by” relationship; a “uses” relationship; a “calls” relationship; or a “called by” relationship.
